(19) United States
(12) Patent Application Publication
(10) Pub. No.: US 2021/0179881 A1
(43) Pub. Date: Jun. 17, 2021

(54) SILVER PASTE AND COATINGS PRODUCED THEREFROM

(71) Applicant: Merck Patent GmbH, Darmstadt (DE)

(72) Inventors: Anja KILIAN, Darmstadt (DE); Lydia MALLIG, Darmstadt (DE); Khwan Khung LIM, Singapore (SG)

(73) Assignee: Merck Patent GmbH, Darmstadt (DE)

(21) Appl. No.: 17/119,155

(22) Filed: Dec. 11, 2020

(30) Foreign Application Priority Data
Dec. 12, 2019 (DE) 102019008616.3

(51) Int. Cl. C09D 17/00; C09D 5/38; C08K 3/08; C08L 83/04; C08L 83/16; C08L 93/04; C08K 5/098

(52) U.S. Cl. CPC C09D 17/006; C09D 5/38; C08K 3/08; C08L 83/04; C08L 83/16; B82Y 40/00; C08K 5/098; C08K 2003/0806; C08K 2201/003; C08K 2201/011; C08L 93/04

(57) ABSTRACT

The present invention relates to an oxidation-stable silver paste comprising silver nanoparticles, and to the use of a paste of this type for the production of decoration elements having a metallic luster on articles having an outer silicate surface, such as porcelain, ceramic, bone china, glass or enamel, to metallic coatings on such substrates and to a process for the production of coatings of this type.

The present invention relates to an oxidation-stable silver paste comprising silver nanoparticles, and to the use of a paste of this type for the production of decoration elements having a metallic luster on articles having an outer silicate surface, such as porcelain, ceramic, bone china, glass or enamel, to metallic coatings on such substrates and to a process for the production of coatings of this type.

Decorative metallic coatings are highly desired for various consumer goods and architectural decoration elements. In particular, decoration elements colored with noble metals, such as gold, palladium and platinum, provide such goods with the feeling of value and exclusivity.

In general, preparations comprising noble metals for the decoration of glass, porcelain, bone china, ceramic or similar surfaces consist of fluxes, binders and solutions of organic gold, organic palladium and/or organic platinum compounds dissolved in suitable organic solvents. Compositions of this type exhibit good adhesion to the respective substrate. After application to the substrate surface, the metal paste is thermally treated and decomposes to form the corresponding metal oxides and/or metals, which adhere to the substrate and, depending on the starting compounds, exhibit a lustrous or silk visual impression of the surface decorations of gold or platinum color. However, the use of noble-metal compounds, such as organic gold compounds, organic palladium compounds and organic platinum compounds, for the generation of platinum-colored effects is very expensive.

Although silver compounds are suitable for use as starting material for the production of decorative platinum effects on silicate surfaces, the decomposition of organic silver compounds alone does not, however, lead to lustrous, attractive silver-colored decorations on silicate surfaces, since defined metallic silver films or silver particles cannot be formed without uncontrolled formation of dark silver oxide as an undesired by-product. A further disadvantage of these silver-containing formulations is that they then turn grey and consequently lose luster. In order to obtain adequate passivation, it must be ensured that the respective paste has a correspondingly high SiO₂ content. In addition, the prior-part formulations have the problem that the binders are frequently not capable of taking up SiO₂-forming substances to a sufficient extent without this having an adverse effect on the paste stability.

Although it is possible to generate a sufficiently high SiO₂ content in the formulation using the metal preparations known, for example, from WO 2018/163133 A1 and WO 2018/162550 A1, these formulations do not, however, have adequate paste stability and can no longer be applied after just a short time. The prior-art pastes thus give rise to either inadequately protected metal decorations, i.e. an inadequate proportion of glass matrix for protection of the nanoparticles, or simply inadequately stable pastes, since, owing to the high proportion of SiO₂ precursors for glass formation, they tend to undergo condensation reactions. These reactions lead to agglomeration of the silver nanoparticles. Furthermore, the metal decorations obtained then exhibit a particulate surface and not the desired homogeneous high-luster coating. It is furthermore problematic that the metal decorations have inadequate adhesion to the substrate if the SiO₂ content of the decoration is too low.

In particular, it is disadvantageous that the metallic decorations known from the prior art are unstable when they are exposed to H2S-containing atmospheres. For example, if decorations are stored in paper or cardboard, these decorations are continuously subjected to the release H2S gas due to the paper or cardboard production process.

The object of the present invention is therefore to provide stable silver-containing pastes which do not have the above-mentioned disadvantages and are suitable for the coating of glass-like or ceramic substrates and which simultaneously develop a noble-metal effect after firing, where the coating/decoration is stable to H2S-containing and other oxidizing atmospheres. This stability requires that a sufficiently thick and dense glass-like layer forms during the firing process and surrounds the silver nanoparticles and in this way provides protection against oxidation. Furthermore, the paste must be composed in such a way that the nanoparticles do not form agglomerates or agglomerate formation is substantially suppressed. The formation of agglomerates has an adverse effect on the luster and visual impression of the surface decoration and leads to metal decorations or metal coatings having a particulate surface.

Surprisingly, it has now been found that stable silver nanoparticle-containing pastes having a high silicon dioxide content can be prepared if the paste comprises silver nanoparticles, a natural resin as binder and an SiO₂ precursor. Suitable natural resins are preferably resins of colophony, terpene and abietic acid as well as derivatives and condensation products thereof.

The present invention relates to a silver paste which comprises
A) 10 to 40% by weight of nanoparticles comprising silver or a silver-containing alloy, where the nanoparticles have a D₅₀ value, measured using the volume-based laser diffraction process, of 30-300 nm,
B) 10 to 30% by weight of at least one organic compound containing silicon, C) 30 to 70% by weight of a solvent or solvent mixture,
D) 15 to 35% by weight of at least one natural resin,
E) 0 to 30% by weight of at least one organic metal, alkaline-earth metal or alkali metal compound, where the chemical element is selected from the group Ag, Au, Bi, Ca, Co, Cr, Cu, Fe, Ir, K, Mg, Mn, Na, Nb, Ni, Os, Pd, Pt, Os, Rh, Ru, Sn, Ti, W, V, Zn, Zr,
F) 0 to 10% by weight of one or more additives, and
G) 0 to 10% by weight of one or more synthetic resins,
where the percent data relate to the total weight of the silver paste and add up to 100%.

With the aid of the silver paste according to the invention comprising components A) to D) and optionally components E) and/or F) and/or G), it is possible to apply compact and stable coatings to silicate surfaces, where the coatings are stable and have a very high metallic luster, since agglomerate formation of the silver nanoparticles is substantially suppressed. The silver pastes according to the invention are therefore eminently suitable as decoration or inscriptions on surfaces consisting, for example, of porcelain, bone china, ceramic, glass or enamel, since, besides the optical properties, they also have very good adhesion to the surface.

The present invention also relates to the use of the silver pastes according to the invention for coating, for the production of decoration elements or for the inscription of articles which have a porcelain, bone china, ceramic, glass or enamel surface.

An essential constituent of the metal preparation according to the invention are the nanoparticles comprising silver or a silver-containing alloy (component A)). The nanoparticles particularly preferably consist of a silver alloy comprising at least 50% by weight of silver, based on the total weight of the alloy. Nanoparticles comprising silver and nanoparticles consisting of silver alloys are commercially available, for example, from nanoComposix, Sky Spring Nanomaterials, Nano Technology, NTbase, EPRUI Nanoparticles & Microspheres, Chengdu Alpha Nano Technology, Cline Scientific, Nanocs, Sun Innovations, SkySpring Nanomaterials, PV nancel, Dowa.

Suitable nanoparticles have a D₅₀ value of 30-300 nm, in particular 30 200 nm and very particularly preferably of 50-100 nm (measured using the volume-based laser diffraction process determined by Malvern Instruments Limited).

The nanoparticles should preferably be in monodisperse form and not agglomerated in order to ensure the formation of a lustrous film.

In a particularly preferred embodiment, stabilized silver nanoparticles are employed. The stabilization has the job of preventing agglomerates of nanoparticles forming during storage and application. For the development of the luster effect, it is advantageous if the nanoparticles are in monodisperse form until the firing operation.

Stabilizers which are suitable for silver are, for example, citrates, such as, for example, trisodium citrate, carbohydrates, such as, for example, glucose, lactose, polysaccharides, polyvinylpyrrolidone, sodium dodecylsulfate, cetyltrimethylammonium bromide, carboxymethylcellulose, polyethylene glycol, gallic acid, oleic acid and polyacrylic acid.

The proportion of the stabilization is preferably 0-10% by weight, in particular 0-5 Gew-% and very particularly preferably 0-1% by weight, based on the silver nanoparticles.

The proportion of component A) in the silver paste is 10-40% by weight, in particular 10-30% by weight and very particularly preferably 15-25% by weight.

For the formation of SiO₂ as protective layer for the nanoparticles and as glass-forming constituent (component B)), the silver paste according to the invention must comprise an organic SiO₂ precursor. All organic compounds containing silicon that are known to the person skilled in the art are suitable, such as, for example, silicon-containing polymers, oils or resins, silicic acid esters, and sol-gel-like silicon-containing precursors. Suitable silicon-containing polymers are, for example, polysiloxanes, polysilazanes, polysilsesquioxanes, polycarbosilanes, polycarbosiloxanes, polysilanes, polysilylcarbodiimides, polysilsesquicarbodiimides, polysilsesquiazanes, polyborosilanes, polyborosilazanes, polyborosiloxanes and mixtures thereof.

Silicones, polysiloxanes, polysilsesquioxanes, polysilanes, polysilanols or derivatives thereof are preferably employed. It is furthermore also possible to employ mixtures of the said organic compounds and polymers.

Component B) is preferably an oxygen- or nitrogen-containing organic silicon compound which forms an Si—O-based network on thermal decomposition in an oxygen-containing atmosphere. In order to be useful for the present purpose, the corresponding oxygen- or nitrogen-containing organic silicon compound must not evaporate before it decomposes. Silicon-containing polymers, such as, for example, polysilazane compounds, polysiloxane compounds and silicone resins of the general formulae 1, 2, 3 or 4 are partitularly advantageously suitable as oxygen- or nitrogen-containing organic silicon compound:

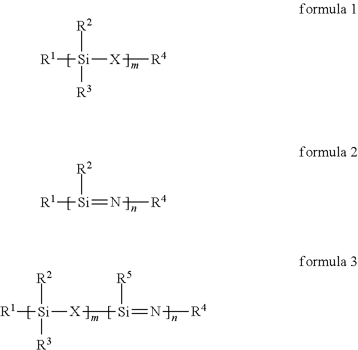

in which
R¹ is a radical selected from the group consisting of H, C₁-C₁₈-alkyl, C₅-C₆ cycloalkyl, substituted or unsubstituted phenyl, OH, OC₁-C₁₈-alkyl, NH₂, and N(C₁-C₁₈-alkyl)₂;
R², R³
and R⁵, independently of one another, are a radical selected from the group consisting of H, C₁-C₁₈-alkyl, OH, OC₁-C₁₈-alkyl, NH₂, N(C₁-C₁₈-alkyl)₂, OSi(R¹)₃, and N═SiR¹;
R⁴ is a radical selected from the group consisting of H, C₁-C₁₈-alkyl, C₅-C₆-cycloalkyl, methacrylate and phenyl;
X is a radical of 0 or N; and
m and n, independently of one another, are an integer selected from the numbers in the range from 1 to 100.

Also advantageously suitable are furthermore silsesquioxane polymers of the general formula 4:

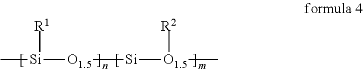

in which
R¹ and R² are radicals which are identical or different from one another and are selected from the group consisting of hydrogen, alkyl, cycloalkyl, aryl, and alkoxy, and
m and n, independently of one another, are an integer selected from the numbers in the range from 1 to 100,
and polysilanes and silicic acid esters of the formulae (I) and (II):

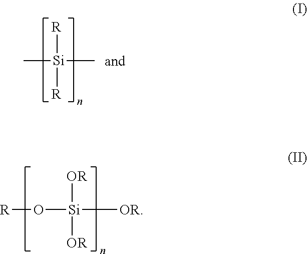

It goes without saying that it is possible for the polymers to have been polymerized not only in a linear manner, but also in a cyclic manner.

Further silicon-containing polymers which are suitable as SiO₂ precursor include silicone-modified alkyd resins and silicone polyester resins. Component B) is preferably a compound or polymer selected from the group of the polysilazanes, polysiloxanes, silicones, silicone-modified alkyd resins, silicone polyester resins, polysilsesquioxanes, polysilanes, polysilanols or derivatives thereof as well as mixtures of the said organic compounds and polymers.

The boiling point of the SiO₂ precursors should preferably not be below the firing temperature of the decoration. The SiO₂ precursor should preferably be selected so that adequate crosslinking takes place before the firing process in order that SiO₂ fractions do not evaporate.

Suitable silicon-containing organic compounds and polymers are commercially available under the trade names Silres® (Wacker), Dowsil™ (Dow Chemicals), Durazan™ (Merck), KF series (ShinEtsu) and CoatOSil, SilFORT, SilForce (Momentive Performance Materials).

The proportion of the SiO₂ precursor in the silver paste is 10-30% by weight, in particular 12-28% by weight and very particularly preferably 14-25% by weight, based on the silver paste.

This (these) organic compound(s) in component B) act as glass former in the resultant solid coating on a substrate, since they decompose on thermal treatment without leaving a residue to give SiO₂-containing glasses.

After firing, the content of SiO₂ (glass matrix) is preferably 15 to 45% by weight, in particular 20 to 40% by weight, based on the total weight of the solid coating.

As further constituent, the silver paste comprises 30 to 70% by weight, preferably 32-65% by weight and in particular 35-60% by weight, of a solvent or solvent mixture (component C)), based on the total weight of the silver paste. The job of the solvent is, in particular, to dissolve the natural resin. The solvent can be aqueous or organic, depending on the natural resin employed; organic solvents are preferably employed.

All organic solvents known to the person skilled in the art which are capable of dissolving the natural resins of component D), do not have an adverse effect on the paste stability and which evaporate without leaving a residue at the temperature of the thermal treatment of the resultant coating layer on the silicate substrate can be used for the preparation of the silver paste according to the invention. The choice of solvent furthermore depends on the application method. Crucial properties which may be mentioned here are the viscosity and the evaporation rate of the solvent.

Examples of suitable solvents are at least one selected from the group alcohols, aromatic solvents, ketones, esters, ethers, ether alcohols, saturated and unsaturated aliphatic hydrocarbons or amides. Suitable alcohols are, for example, ethanol, isopropanol, hexanol or 2-ethylhexanol, ethoxyethanol, methoxyethanol, methoxypropanol and mixtures thereof. Ethers of polyalcohols are also highly suitable, in particular tripropylene glycol monomethyl ether (TPM) and dipropylene glycol monomethyl ether (DPM). Particular preference is given to 2-ethylhexanol, tripropylene glycol monomethyl ether (TPM) and dipropylene glycol monomethyl ether (DPM). All solvents can be used as the sole solvent or in a mixture comprising a plurality of solvents.

Non-alcoholic solvents may optionally also be present in the solvent mixture, for example, but not restricted to, ethers, such as dialkylpropylene glycols, dioxane or THF, aromatic solvents, such as xylenes, saturated and unsaturated aliphatic hydrocarbons, such as terpenoid solvents and naphtha, amides, such as N-ethylpyrrolidone, esters, such as ethyl benzoate or fatty acid esters, in an amount of 1 to 40% by weight, based on the weight of the solvent mixture.

Particularly preferred solvents are terpineol, 1-methoxy-2-propanol (PM), dipropylene glycol methyl ether (DPM), tripropylene glycol monomethyl ether (TPM), terpentine, pinene, pinanol, borneol, myrcenol, dihydrocarveol, nerol, geraniol, linalool and terpenes and mixtures thereof.

By variation of the amount and type of the solvents, the viscosity of the silver paste in accordance with the present invention can be adjusted to a value which is useful and suitable for the applicable coating or printing technique. It is a major advantage of the present invention that the silver paste can be used in a number of coating or printing techniques, making it possible to prepare a concentrated silver paste which can be diluted to the requisite value by simple adjustment of the solvent content and is thus of utility for a number of coating or printing techniques, including ink-jet printing.

As binder, the silver paste according to the invention comprises 15 to 35% by weight of at least one natural resin (component D)). The binder contributes to fixing the viscosity of the silver paste during the printing process. Although the silver paste must have a viscosity that is sufficiently low to be capable of being printed or applied in various printing or coating processes, the respective coating or print layer must keep its shape after application to the substrate without spreading beyond the coated surface. This property is vital for printing sharp edges and motifs. In addition, the binder must burn off completely during the thermal treatment of the resultant coating or print layer in the area of application of the present silver paste. A further job of the binder is to ensure film formation of the silver nanoparticles during the firing operation.

All natural resins known to the person skilled in the art are suitable, in particular non-hydrogenated, partially hydrogenated and/or fully hydrogenated resins based on colophony, non-hydrogenated, partially hydrogenated and/or fully hydrogenated resins based on colophony esters, non-hydrogenated, partially hydrogenated and/or fully hydrogenated resins based on crude tall oil, non-hydrogenated, partially hydrogenated and/or fully hydrogenated resins based on crude tall oil esters, terpene-based resins and/or the respective derivatives thereof and mixtures of the said resins. The principal constituents of the above-mentioned colophony resins are resin acids, principally comprising pimaric acid and abietic acid. Furthermore, the resins may be partially dimerized or polymerized.

The binder particularly preferably consists of a colophony-based resin. Resins which are suitable as binder are commercially available under the trade names Gum Rosin (Sigma Aldrich), Dymerex™ (Eastman), Rosin WW (TER Chemicals), Poly-Pale™ (Eastman), Bremar (Kraemer).

In order to increase and stabilize the noble-metal film, for example with respect to adhesion and scratch resistance, and the luster and in order to establish the desired hue, the silver paste may comprise as optional component (component E)) 0 to 5% by weight of at least one organic metal, alkaline-earth metal or alkali metal compound, where the chemical element is selected from the group Ag, Au, Bi, Ca, Ce, Co, Cr, Cu, Fe, Ir, K, Mg, Mn, Na, Nb, Ni, Os, Pd, Pt, Os, Rh, Ru, Sn, Ti, W, V, Zn, Zr.

Preferred organic metal-containing compounds are noble metals from the group Ag, Au, Pd, Pt, Os, Rh and Ru.

Preference is given to the use of organic metal salts, such as, for example, resinates, sulforesinates, mercaptides, thiolates, carboxylates, ethylhexanoates and alcoholates. The organic metal salts are usually used in a solvent or solvent mixture.

Preferred solvents for dissolution of the organic metal component are the organic solvents indicated under component C).

The metal compound of component E) generally improves the adherence of the silver paste according to the invention to the substrate after the firing operation. During the final thermal treatment of the silver paste on the coated substrate, the organic metal compound is decomposed to the corresponding metal oxide and/or metal and thus acts as fluxing agent. A further function of component E) is the possibility of adjusting the hue of the film formed.

The silver paste according to the invention may, for the particular application, optionally comprise one or more additives (component F)), for example thixotropic agents, flow-control agents, dispersants, rheology modifiers, antifoams, surfactants, fillers and dyes.

The silver paste according to the invention may, for example, comprise a rheology modifier if the viscosity of the silver paste has to be specifically adjusted further. The rheology modifier can be present in an amount of 0 to 10% by weight, based on the total weight of the silver paste. An amount of 0 to 8% by weight, in particular 0 to 5% by weight, is preferably used. Suitable rheology modifiers are, for example, pine oil, castor oil, fatty acids and fatty acid derivatives, and natural and synthetic waxes.

Examples of fatty acids are linoleic acid, oleic acid, stearic acid, palmitic acid, myristic acid, lauric acid and capric acid and derivatives thereof.

Examples of natural and synthetic waxes are montan waxes of the C₁₉- to C₃₀-hydrocarbons, carnauba wax, tan waxes, colophony waxes or polyolefin waxes, such as, for example, Ceridust® waxes from Clariant, to mention just a few.

Suitable dispersants are non-surface-active polymers or surface-active substances. The dispersant serves to improve the film formation of metal particles of component A) and to prevent settling and/or agglomeration. This ensures that a lustrous film forms during the firing process.

There is a broad range of non-surface-active polymers that can function as effective dispersants, such as, for example, polyacrylic acid, polyacrylates and copolymers thereof, polyurethanes and polyvinylpyrrolidone.

Surface-active substances which can be employed are all compounds known to the person skilled in the art. Suitable surface-active substances can be selected, for example, from the group consisting of a non-ionic surfactant, an anionic surfactant, a cationic surfactant and an amphoteric surfactant and mixtures of the said surfactants. All said surfactants contain a non-polar part and a polar part. The non-polar part can be selected from groups, including branched, linear or aromatic groups, such as an alkyl group, an alkylbenzene group and combinations thereof. The polar part of the non-ionic surfactants can be selected from the group consisting of an alcohol group, an ether group, an ester group, an amide group, an acrylate group and combinations of at least two thereof. The polar part of the anionic surfactant can be selected from the group consisting of a carboxylate, a sulfonate, a sulfate, a phosphate and mixtures of at least two thereof. The polar part of the cationic surfactant can be, for example, an optionally substituted ammonium group. The polar part of the amphoteric surfactant can be selected from combinations of at least one polar part of a cationic surfactant and of an anionic surfactant.

Examples of non-ionic surfactants include, for example, long-chain aliphatic alcohols, ethoxylated aliphatic alcohols (such as octaethylene glycol monododecyl ether or pentaethylene glycol monododecyl ether), polypropylene glycol alkyl ethers, glucoside alkyl ethers, polyethylene glycol octylphenyl ethers (such as, for example, Triton X-100), polyethylene glycol alkylphenyl ethers, glycerin alkyl esters, polyoxyethylene glycol sorbitan alkyl esters, sorbitan alkyl esters, cocamide-MEA, cocamide-DEA, dodecyldimethylamine oxide, polyethoxylated tallow amine carboxylic acid esters, polyethylene glycol esters, glycol esters of fatty acids, carboxylic acid amides, monoalkanolamine condensates or polyoxyethylene fatty acid amides.

Examples of anionic surfactants include: alkylcarboxylates, such as, for example, sodium stearate, alkylsulfates, alkylbenzenesulfonates, naphthalenesulfonates, olefinesulfonates, alkylsulfonates, sulfated natural oils, natural oils and fats, sulfated esters, sulfate alkanolamides, ethoxylated and sulfated alkylphenols. Important alkylsulfates include ammonium lauryl sulfate, sodium lauryl sulfate (“SLS” or “SDS”) and the related alkyl ether sulfates sodium laureth sulfate (“SLES”) and sodium myreth sulfate. Also suitable are dioctyl sodium sulfosuccinate, perfluorooctane sulfonate, perfluorobutane sulfonate, alkyl aryl ether phosphates, alkyl ether phosphates, phosphates of ethoxylated aliphatic alcohols. More specialized carboxylates include sodium lauroyl sarcosinate and carboxylate-based fluorosurfactants, such as, for example, perfluorononanoate or perfluorooctanoate (“PFOA” or “PFO”).

Examples of cationic surfactants include: pH-dependent primary, secondary or tertiary amines and ammonium salts thereof, including quaternary ammonium salts. The permanently charged quaternary ammonium salts include: cetrimonium bromide, cetylpyridinium chloride, benzalkonium chloride, benzethonium chloride, dimethyldioctadecylammonium chloride, dioctadecyldimethylammonium bromide, amines containing amide bonds, polyoxyethylene alkylamines and alicyclische amines; N,N,N′,N′-tetrakissubstituted ethylenediamines and 2-alkyl-1-hydroxyethyl-2-imidazolines.

The cationic part of amphoteric surfactants is based on primary, secondary or tertiary amines or quaternary ammonium cations. The anionic part can be more variable and include sulfonates, as in the sultaines CHAPS (3-[(3-cholamidopropyl)dimethylammonio]-1-propane sulfonate) and cocamidopropyl hydroxysultaine. Betaines, such as cocamidopropylbetaine, contain a carboxylate with the ammonium. The most common biological zwitterionic surfactants contain a phosphate anion with an amine or ammonium, such as the phospholipids phosphatidylserine, phosphatidylethanolamine, phosphatidylcholine and sphingomyeline.

In the present invention, the use of anionic surfactants, such as phosphates of ethoxylated aliphatic alcohols, is preferred.

However, the prerequisite for all additives comprising organic compounds is that the additives decompose without leaving a residue on thermal treatment and do not have an adverse effect on the stability of the paste according to the invention.

The additives are employed in amounts of 0-10% by weight, preferably 0-7% by weight and in particular 0-5% by weight, based on the composition of the silver paste. If a plurality of different additives are employed, the total proportion of all additives, based on the silver paste, is 10% by weight.

As a further optional component (component G)), the additional addition of one or more synthetic resins may be desired, such as, for example, in the preparation of screen-printing pastes which are suitable for the printing of transfers. The addition of a synthetic resin can, for example, improve the elasticity of the transfer film in certain applications in order to prevent it from tearing on application to hollowware or strongly curved surfaces. Suitable synthetic resins are, for example, alkyd, phenolic, amino, epoxy, polyester, polyacrylate, polyurethane, polyamide, vinyl and furan resins. Particular preference is given to alkyd resins, polyurethane resins and epoxy resins. Component G) is particularly important for the preparation of especially opaque pastes.

In a preferred embodiment, the silver paste according to the invention consists of components A) to G) and particularly preferably of components A) to E).

It goes without saying that all percentages by weight given above, unless indicated otherwise, are based the total weight of the silver paste.

The present invention also relates to a process for the preparation of the silver paste according to the invention, which is characterized in that compulsory components and any optional components are mixed intimately with one another, preferably at room temperature, in order to obtain a ready-to-use silver paste. A solution of the natural resin (constituent D) is preferably prepared and the other constituents, preferably mixed with a solvent or solvent mixture, are added successively. If desired or necessary, one or more additives can also be added. The mixing is preferably carried out using a rotor-stator homogenizer, a triple-roll mill or a speed mixer. In some cases, degassing may be important, depending on the amount and type of the solvent used. It is of course possible to use a temperature which is suitable for the solvent for the dissolution and/or mixing of the individual components.

It is a major advantage of the present invention that the process for the preparation of the silver paste according to the invention is relatively simple. Simple mixing of components A) to D) and optionally addition of components E) to G) is sufficient to obtain a stable silver paste which has a shelf life of several months and can be stored in sealed containers at least so long without degradation or decomposition of the solid constituents occurring. Depending on the content of solvents, rheology modifiers and/or other thixotropic agents, the silver paste according to the invention can be used in various coating or printing processes, including ink-jet printing. A concentrated form of the silver paste according to the invention can therefore serve the customer for application thereof in a number of coating or printing processes, since the solvent content can be adjusted by the customer, even at a later point in time. Settling of components, especially of component A), is a usual occurrence for pastes. For the paste according to the invention, however, this does not mean any restriction in shelf life. Owing to the composition and stabilization, the paste can be re-homogenized by simple stirring before use without the effect being adversely affected thereby.

In order to obtain metal decorations of this type on silicate surfaces as mentioned above, the silver paste according to the invention must be applied to a surface of an article and subsequently treated further.

The present invention therefore also relates to a process for the production of a metal-containing coating on a substrate, where the silver paste according to the invention is applied to a substrate and subsequently treated at a temperature of 400-900° C., preferably 500-850° C., and in particular 550 800° C. The treatment is preferably carried out in an oxygen-containing atmosphere. The firing temperature essentially depends on the surface to be coated and the softening point of the article to be decorated. The maximum temperature is determined by the melting point of component A).

In accordance with the present invention, the substrate with the silicate surface is preferably an article having a porcelain, bone china, ceramic, glass or enamel surface. The type of article is not restricted per se. In principle, it is possible to use all articles whose decoration or function can be enhanced by having a metallic layer or decoration or inscription produced with the aid of the silver paste according to the invention on its surface. Examples are glazed tiles, architectural elements, glasses and porcelain for private or commercial use and the like.

The silver paste according to the invention can be applied to the surface of the substrate other directly or by means of a transfer medium.

Direct application can be carried out by any method known to the person skilled in the art. The silver paste according to the invention can be applied to the substrate by dipping the substrate into the silver paste to be applied or by any desired coating or printing process, such as curtain coating, roller coating, spin coating, impregnation, pouring, dripping, squirting, spraying, knife coating, painting or printing, where printing can be an ink-jet printing, screen printing, gravure printing, offset printing or pad printing process and the painting process can be pen painting, brush painting or similar process.

The coating process is selected depending upon the type of substrate and the size and type of coating that is to be applied to the substrate. It goes without saying that the viscosity of the silver paste according to the invention must be matched to the requisite coating technique. Since the viscosity of the silver paste according to the invention can generally be adjusted by changing the amount of the respective solvent or solvent mixture, a concentrated silver paste in accordance with the present invention can be used as base composition for use in more than one application technique.

Preferred printing processes are screen printing, gravure printing, pad printing and ink-jet printing. Painting by means of a brush or pen as well as rim application by means of a copper wheel can also advantageously be used.

The application of the silver paste to the substrate can also be carried out using an indirect process, i.e. by applying the applicable silver paste to a transfer medium in a first step, and, in a second step, applying the silver paste to the substrate by means of the transfer medium which has been pre-coated with a silver paste in accordance with the present invention. The silver paste can be applied to the transfer medium here via a printing process, such as screen printing, ink-jet printing, pad printing, or offset printing.

The transfer medium can consist of a polymer or paper carrier, e.g. in the form of a transfer which is pre-coated with the silver paste according to the invention and dried. The silver paste according to the invention is then applied to the substrate by positioning the pre-coated carrier on the substrate and removing the polymer or paper carrier. The thermal treatment is in this case carried out after application of the silver paste to the substrate, not after application of the silver paste to the polymer or paper carrier.

The substrate can have any desired shape that allows the application of the applicable silver paste to the substrate. Flat, two-dimensional substrates, such as films, plates and sheets, are just as useful as three-dimensional substrates having any desired shape, such as a sphere or cone or any other appropriate three-dimensional shape desired. The substrate can be a compact or hollow body having an external and/or internal glazed surface on porcelain, bone china, ceramic, glass or enamel which is intended to be covered or inscribed with a silver paste of the present invention.

The silicatic surface of the substrate preferably includes at least one coherent area to which the silver paste according to the invention can be applied. The area covered with the silver paste can have any desired suitable shape, in the form of regular or irregular patterns, lines, geometric shapes, such as circles, squares, rectangles and the like, photographs, logos, bar codes, etc. Size and shape of the substrate area covered with the silver paste are limited merely by the type of coating or printing process used and/or by the geometrical shape of the substrate itself. In the case of porous and absorbent ceramic bodies, it is advantageous to apply a glaze before the decoration. The present coating process allows the production of patterns having very fine line diameters.

The size of the coated area is generally in the range of from 0.5 mm² to m², in particular from 10 mm² to 5 m², and particularly preferably in the range from 100 mm² to 1 m². Line diameters of 0.01 mm to 10 cm, in particular 0.1 mm to 1 cm, are also possible.

The substrate on which the solid decoration layer is located is an article having an outer silicate surface, which is, for example, a porcelain, bone china, ceramic, glass or enamel surface. It goes without saying that it is possible for the entire article to consist of one of the above-mentioned materials, but articles which merely have a silicate surface, with the body of the article consisting of another material, are likewise intended to be part of the present invention. The surface of the article and its body must naturally withstand the temperature of the thermal treatment at 400-900° C. Shape and size of the article itself are not subject to any restriction. The silicate surface can be either an external surface or an internal surface of the article (for example for hollow articles).

The content of the glass matrix is preferably 15-45% by weight, in particular 20-40% by weight, based on the total weight of the solid coating. The content of the silver nanoparticles in the metal particle-containing solid coating on the substrate is therefore preferably 40-80% by weight, particularly preferably in the range 50-70% by weight of the total weight of the solid coating. If the solid coating comprises further metals, their content is in the range from 0-10% by weight, based on the solid coating.

Particular preference is given to the embodiment in which the solid coating on a substrate only comprises silver particles or a silver-containing alloy having a silver content of at least 50% by weight, based on the weight of the alloy, and a surrounding glass matrix.

As soon as the pastes have been fired, the stability to oxidation can be tested with reference to test standards. The ISO 4538-1978 (E) standard is used for this purpose.

The present invention is explained in greater detail by the following examples, but is not intended to be restricted thereto.

### EXAMPLES

### Example 1

A resin solution prepared from 50% of Dymerex™ (colophony resin from Eastman) and 50% of 1-methoxy-2-propanol is employed as binder. 3 g of the above solution are initially introduced. 4 g of a paste of silver nanoparticles (D₅₀₌₇₀ nm, D₉₀₌₁₁₅ nm, in ethanol, solids content 45%, NanoComposix), 2 g of a polymer mixture (Dowsil™ Fluid 593: polydimethylsiloxane/silicone resin mixture, Dow Chemicals), 0.1 g of platinum resinate MR7801-P (Alfa Chemistry), 0.2 g of bismuth(III) 2-ethylhexanoate (ABCR) and 0.7 g of 1-methoxy-2-propanol are subsequently added. The mixture formed is stirred until homogeneous.

The silver paste obtained in this way, which is particularly suitable for brush application, is then applied to a glass by brushing. After drying, the decorated glass is fired at 560° C. for 30 minutes. In this way, a particularly lustrous, dark platinum-like decoration is obtained on the glass surface.

### Example 2

A resin solution, prepared from 70% of Dymerex™ (colophony resin from Eastman) and 30% of Dowanol DPM (dipropylene glycol monomethyl ether), is employed as binder. 4 g of the above solution are initially introduced. 4 g of a paste of silver nanoparticles (D₅₀₌₇₀ nm, D₉₀₌₁₁₅ nm, in ethanol, solids content 45%, NanoSaar AG), 1 g of a polymer mixture (Dowsil™ Fluid 593: polydimethylsiloxane/silicone resin mixture, Dow Chemicals), 0.1 g of platinum resinate MR7801-P (Alfa Chemistry), 0.2 g of bismuth(III) 2-ethylhexanoate (ABCR) and 0.7 g of 1-methoxy-2-propanol are subsequently added. The mixture formed is stirred until homogeneous.

The viscous silver paste obtained in this way, which is suitable for printing, is then applied to a glass. After drying, the decorated glass is fired at 560° C. for 30 minutes. In this way, a lustrous, platinum-like decoration is obtained on the glass surface.

### Example 3

A resin solution, prepared from 60% of Poly-Pale™ (partially dimerized colophony resin from Eastman) and 40% of terpineol, is employed as binder. 4 g of the above solution are initially introduced. 4 g of a paste of silver nanoparticles (D₅₀₌₇₀ nm, D₉₀₌₁₁₅ nm, in DPM, solids content 45%, DOWA Electronics Materials Co., Ltd.), 1 g of a polymer mixture (DX175 from Shin-Etsu), 0.1 g of platinum resinate (Fuji), 0.2 g of bismuth(III) 2-ethylhexanoate and 0.7 g of 1-methoxy-2-propanol are subsequently added. The mixture formed is stirred until homogeneous.

The metal paste obtained is then applied to a glass by means of screen printing. After drying, the decorated glass is fired at 560° C. for 30 minutes. In this way, a silk, platinum-like decoration is obtained.

### Example 4

A resin solution, prepared from 50% of Poly-Pale™ (partially dimerized colophony resin, Eastman) and 50% of terpineol, is employed as binder. 4 g of the above solution are initially introduced. 4 g of a paste of silver nanoparticles (D₅₀₌₇₀ nm, D₉₀₌₁₁₅ nm, in DPM, solids content 45%, DOWA Electronics Materials Co., Ltd.), 2 g of a polymer mixture RHODORSIL HARZ 6405 X (methylphenyl-silicone resin from Bluestar Silicones), 0.1 g of palladium resinate (Alfa Chemistry), 0.2 g of bismuth(III) 2-ethylhexanoate and 0.7 g of 1-methoxy-2-propanol are subsequently added. The mixture formed is stirred until homogeneous. The silver paste formed, which is particularly suitable for screen printing, is then applied to a glass by means of screen printing. After drying, the decorated glass is fired at 560° C. for 30 minutes. In this way, a lustrous, whitegold-like decoration is obtained.

### Example 5

A resin solution, prepared from 50% of balsam resin (TER Chemicals) and 50% of 1-methoxy-2-propanol, is employed as binder. 4 g of the above solution are initially introduced. 4 g of a paste of silver nanoparticles (D₅₀₌₇₀ nm, D₉₀₌₁₁₅ nm, in terpineol, solids content 50%, PV Nanocell), 2 g of a polymer mixture (Dowsil™ Fluid 593: polydimethylsiloxane/silicone resin mixture (Dow Chemicals), 0.1 g of platinum resinate MR7801-P (BOC Science) are subsequently added. The mixture formed is stirred until homogeneous.

The paste formed, which is particularly suitable for screen printing, can then be applied to a glass. After drying, the decorated glass is fired at 600° C. for 30 minutes. In this way, a particularly lustrous, very bright platinum-like decoration is obtained.

### Example 6

A resin solution, prepared from 50% of gum rosin (Sigma-Aldrich) and 50% of 1-methoxy-2-propanol, is employed as binder. 4 g of the above solution are initially introduced. 4 g of a paste of silver nanoparticles (D₅₀₌₇₀ nm, D₉₀₌₁₁₅ nm, in terpineol, solids content 50%, DOWA Electronics Materials Co., Ltd.), 2 g of a polymer mixture (Dowsil™ 2502, Cetyl Dimethicone, Dow Chemicals), 0.1 g of palladium resinate (Daiken) are subsequently added. The mixture formed is stirred until homogeneous.

The paste formed can then be applied to a glass by means of screen printing, spraying or brushing. After drying, the decorated glass is fired at 560° C. for 30 minutes. In this way, a lustrous, dark white-gold-like decoration is obtained.

### Example 7

A resin solution, prepared from 60% of balsam resin (TER Chemicals) and 40% of 1-methoxy-2-propanol, is employed as binder. 4 g of the above solution are initially introduced. 4 g of a paste of silver nanoparticles (D₅₀=70 nm, D₉₀₌₁₁₅ nm, in terpineol, solids content 50%, PV Nanocell), 2 g of a polymer mixture (Dow-Sil 593), 0.1 g Au resinate (Hereaus) are subsequently added. The mixture formed is stirred until homogeneous.

The silver paste formed is then applied to a glass by means of screen printing, spraying or brushing. After drying, the decorated glass is fired at 560° C. for 30 minutes. In this way, a silk, white-gold-like decoration is obtained.

### Example 8

A resin solution, prepared from 50% of gum rosin (Sigma-Aldrich) and 50% of terpineol, is employed as binder.

4 g of the above solution are initially introduced. 4 g of a paste of silver nanoparticles (D₅₀₌₇₀ nm, D₉₀₌₁₁₅ nm, in TPM, solids content 50%, Seashell Technology, LLC), 2 g of a polymer mixture Silres® HK46 (methylsilicone resin, Wacker), 0.1 g of platinum resinate MR7801-P (Alfa Chemistry) are subsequently added. The mixture formed is stirred until homogeneous.

The silver paste formed, which is particularly suitable for screen printing, is then applied to a glass by means of screen printing, spraying or brushing. After drying, the decorated glass is fired at 620° C. for 30 minutes. In this way, a lustrous, extremely resistant platinum-like decoration is obtained.

### Example 9

A resin solution, prepared from 50% of BREMAR 6091 (Robert Kraemer GmbH) and 50% of 1-methoxy-2-propanol, is employed as binder. 4 g of the above solution are initially introduced. 4 g of a paste of silver nanoparticles (D₅₀₌₇₀ nm, D₉₀₌₁₁₅ nm, in terpineol, solids content 50%, PV Nanocell), 3 g of a polymer mixture Durazane 1066 (silicone resin, Merck KGaA), 0.1 g of platinum resinate MR7801-P (Alfa Chemistry) are subsequently added. The mixture formed is stirred until homogeneous. The paste formed is then applied to a glass by means of screen printing, spraying or brushing. After drying, the decorated glass is fired at 560° C. for 30 minutes. In this way, a particularly scratch-resistant, lustrous, platinum-like decoration is obtained.

The decorations of Examples 1-9 are H2S-resistant, oxidation-stable and exhibit no greying in accordance with the ISO 4538-1978 (E) standard. Depending on the atmosphere, the decoration is then stable for many years.

### Example 10

40 g of cyclohexanone are heated at a temperature of 120° C. 20 g of SYNOLAC® 3132×75 from Arkema and 40 g of Rosin WW (TER Chemicals) are added with stirring until everything has dissolved. A clear brown solution is visible after cooling to room temperature. 30 g of this resin solution are removed and mixed with 10 g of Durazen 1800 (polysilazane from Merck), 1 g of bismuth(III) 2-ethylhexanoate, 0.5 g of 10% Calcium Cem-All (Borchers), 40 g of Ag nanoparticles (D₅₀₌₇₀ nm, D₉₀₌₁₁₅ nm, in TPM (50% solids content in tripropylene glycol monomethyl ether) and 18.5 g of resin solution from Example 2. After brief stirring, this mixture is homogenized in a triple-roll mill. The printing paste prepared in this way is printed directly onto transfer paper with the aid of a screen-printing process (150/31 polyester) and later overprinted with L406 lacquer from Ferro and, after drying, applied to a glass and fired at a temperature of 580° C. A platinum-like hue is obtained.

### Example 11

21 g of Dowanol DPM (dipropylene glycol monomethyl ether) and 10 g of terpineol are slowly added with stirring to 12 g of 3-(trimethoxysilyl)propyl methacrylate from Aldrich.

The mixture is heated to 120° C. with stirring, and 50 g of Poly-Pale Rosin (Eastman) are then added until all resin parts have dissolved. 3 g of gold resinate MR 7901-P (Fuji) and 3 g of palladium resinate MR 4601-P (Fuji) are added. The entire solution is stirred for 3 hours until all the resinates have dissolved. 1 g of cobalt(II) 2-ethylhexanoate solution (“12% Co HexCem” from Borchers) is then added.

This mixture is homogenized in a roll mill. This paste is printed onto transfer paper with the aid of a screen-printing process (150/31 polyester) and allowed to dry in air. It is then overprinted with a lacquer, such as, for example, L406 from Ferro. After application to a glass, the coating is fired at a temperature of 560° C. A platinum hue is obtained.

### Example 12

A resin solution prepared from 60% of gum rosin (Sigma-Aldrich) and 40% of terpineol is employed as binder. 4 g of the above solution are initially introduced. 3.5 g of a paste of silver nanoparticles (D₅₀₌₇₀ nm, D₉₀₌₁₁₅ nm, in terpineol, solids content 50%, PV Nanocell), 2 g of a polymer mixture (Dowsil™ Fluid 593: polydimethylsiloxane/silicone resin mixture (Dow Chemicals), 0.2 g of palladium resinate solution (MR4601-P, Wako Chemicals, w=15% in terpineol) and 0.25 g of a 50% solution of copper resinate (Kremer Pigmente) in terpineol are subsequently added. The mixture formed is stirred until homogeneous.

The silver paste obtained, which is particularly suitable for screen printing, is then applied to a glass by means of screen printing, spraying or brushing. After drying, the decorated glass is fired at 620° C. for 30 minutes. In this way, a lustrous, resistant, very bright, platinum-like decoration is obtained.

1. A silver paste comprising the following components:
A) 10 to 40% by weight of nanoparticles comprising silver or a silver-containing alloy, where the nanoparticles have a D₅₀ value, measured using the volume-based laser diffraction process, of 30 300 nm,
B) 10 to 30% by weight of at least one organic compound containing silicon,
C) 30 to 70% by weight of a solvent or solvent mixture,
D) 15 to 35% by weight of at least one natural resin,
E) 0 to 30% by weight of at least one organic metal, alkaline-earth metal or alkali metal compound, where the chemical element is selected from the group Ag, Au, Bi, Ca, Co, Cr, Cu, Fe, Ir, K, Mg, Mn, Na, Nb, Ni, Os, Pd, Pt, Os, Rh, Ru, Sn, Ti, W, V, Zn, Zr,
F) 0 to 10% by weight of one or more synthetic additives, and
G) 0 to 10% by weight of at least one synthetic resin,
where the percent data are based on the total weight of the silver paste and add up to 100%.

2. The silver paste according to claim 1, wherein the silver nanoparticles employed are monodisperse.

3. The silver paste according to claim 1, wherein the silver nanoparticles employed have been stabilized.

4. The silver paste according to claim 1, wherein the organic compound of component B) is selected from the group polysilazanes, polysiloxanes, silicones, silicone-modified alkyd resins, silicone polyester resins, polysilsesquioxanes, polysilanes, polysilanols or derivatives thereof and mixtures of the said organic compounds and polymers.

5. The silver paste according to claim 1, where the solvent is selected from the group alcohols, aromatic solvents, ketones, esters, ethers, ether alcohols, saturated and unsaturated aliphatic hydrocarbons or amides or mixtures thereof.

6. The silver paste according to claim 1, where the natural resin is selected from the group non-hydrogenated, partially hydrogenated and/or fully hydrogenated resins based on colophony, non-hydrogenated, partially hydrogenated and/or fully hydrogenated resins based on colophony esters, non-hydrogenated, partially hydrogenated and/or fully hydrogenated resins based on crude tall oil, non-hydrogenated, partially hydrogenated and/or fully hydrogenated resins based on crude tall oil esters, terpene-based resins and/or the respective derivatives thereof and mixtures of the said resins.

7. The silver paste according to claim 1, wherein the metal compound of component E) is selected from the group acetates, resinates, sulforesinates, mercaptides, thiolates, carboxylates, ethylhexanoates and alcoholates.

8. The silver paste according to claim 1, wherein the additive of component F) is selected from the group thixotropic agents, flow-control agents, dispersants, rheology modifiers, antifoams, surfactants, fillers and dyes.

9. The silver paste according to claim 1, wherein component G) is a synthetic resin selected from the group phenolic, amino, epoxy, polyester, polyacrylate, alkyd, polyurethane, polyamide, vinyl and furan resins.

10. The silver paste according to claim 1, wherein said nanoparticles of component A) have a D₅₀ value of 30-200 nm.

11. The silver paste according to claim 1, wherein said nanoparticles of component A) have a D₅₀ value of 50-100 nm.

12. The silver paste according to claim 1, wherein the proportion of component A) in the silver paste is 10-30% by weight.

13. The silver paste according to claim 1, wherein the proportion of component A) in the silver paste is 15-25% by weight.

14. The silver paste according to claim 1, wherein proportion of component B) in the silver paste is 12-28% by weight.

15. The silver paste according to claim 1, wherein proportion of component B) in the silver paste is 14-25% by weight.

16. A process for the preparation of a silver paste according to claim 1, comprising intimately mixing all components A) to D) and optiocally components E), F) and/or G) with one another, giving a ready-to-use silver paste.

17. The process according to claim 16, wherein the mixing is carried out using a rotor-stator homogenizer, a triple-roll mill or a speed mixer.

18. A method of producing a coating, decoration element, or inscription on an article having a porcelain, bone china, ceramic, glass or enamel surface comprising applying to said surface a silver paste according to claim 1.

19. The method according to claim 18, wherein, after application of the silver paste to the surface, the silver paste is subsequently treated at a temperature of 400-900° C.

20. The process according to claim 18, the paste is applied to the surface by curtain coating, roller coating, spin coating, impregnation, pouring, dripping, squirting, spraying, knife coating, ink-jet printing, screen printing, gravure printing, offset printing, pad printing, pen painting, or brush painting.
